(19) United States
(12) Patent Application Publication
(10) Pub. No.: US 2012/0073414 A1
(43) Pub. Date: Mar. 29, 2012

(54) ULTRASONIC SYSTEM AND METHOD FOR CUTTING SOFT MATERIALS AND ULTRASONIC HORN BLADE THEREFOR

(75) Inventor: Arthur Summo, Bethel, CT (US)

(73) Assignee: Branson Ultrasonics Corporation, Danbury, CT (US)

(21) Appl. No.: 13/078,064

(22) Filed: Apr. 1, 2011

Related U.S. Application Data
(60) Provisional application No. 61/323,053, filed on Apr. 12, 2010.

(51) Int. Cl. B26D 1/45; B06B 1/00

(52) U.S. Cl. 83/13; 83/646

(57) ABSTRACT

An ultrasonic system and method for cutting soft material has an ultrasonic transducer that vibrates axially at least one horn blade having a serrated edge so that when the horn blade is moved into the food product being cut, it is vibrating in a direction in and out of the food product to make a plunge cut.

### CROSS-REFERENCE TO RELATED APPLICATIONS

This application claims the benefit of U.S. Provisional Application No. 61/323,053 filed on Apr. 12, 2011. The entire disclosure of the above application is incorporated herein by reference.

### FIELD

The present disclosure relates to an ultrasonic system for cutting food products.

### BACKGROUND

This section provides background information related to the present disclosure which is not necessarily prior art.

Ultrasonic systems for cutting soft materials such as food products and synthetic foams are known.

With reference to FIG. 1, a model of a typical ultrasonic system 100 for cutting soft materials such as food products and synthetic foams is shown. As used herein, “soft material” means materials that are easily deformed under light pressure and tend to resist a downward cutting action by compressing rather than being cut. While these materials can be cut using a blade having a serrated edge in a back and forth “sawing” action, this produces excessive cut debris and rough cut edges. Using a blade with a horizontal, smooth edge in a sawing cutting action also produces to some degree excessive cut debris and rough cut edges, and the soft material also tends to compress rather than being cut. It should be understood that such soft materials can include materials having a hard outer shell or crust and a soft interior, such as certain types of breads as well as materials without such a hard crust, such as soft spongy food products. Typical components of ultrasonic system 100 include power supply 101, an ultrasonic transducer 102 coupled to a booster 104 that is coupled to an ultrasonic horn blade 106, sometimes referred to as an ultrasonic guillotine blade. Electrical energy from power supply 101 is converted to mechanical energy by the ultrasonic transducer 102. The ultrasonic transducer 102, booster 104, and horn blade 106 are all mechanically tuned to match the power supply electrical input frequency. The mechanical energy converted in the ultrasonic transducer 102 is transmitted through the booster 104 to the horn blade 106 ultrasonically vibrating horn blade 106. In operation, ultrasonic system 100 is energized and ultrasonically vibrating horn blade 106 moved down into material 108 received on a cutting board 110 which cuts material 108 with an edge 112 of horn blade 106. Cutting board 110 may include a clearance slot 114 for blade 106.

Prior art ultrasonic systems for cutting soft materials have utilized horn blades having horizontal, smooth edges and also serrated edges. Horn blades having horizontal, smooth edges have been vibrated in either axial (up and down) cutting actions (referred to herein as a “plunge cut”) or in a back and forth sawing action. As discussed above, when a blade having a horizontal, smooth edge is used, the soft material tends to compress rather than be cut. Horn blades having serrated edges have been vibrated in a back and forth sawing action. However, horn blades having serrated edges have not been vibrated in an up and down cutting action. When a back and forth sawing action is used, soft material, such as angel food cake, soft bread sandwiches, pound cake, hard crust/soft texture breads and rolls, as well as soft synthetic foams, tend to buckle or pinch when contacted by the ultrasonically vibrating horn blade 106 due to the large surface area of the material 108 with which blade 106 comes into contact, particularly when a blade having a serrated edge is used. This produces the excessive cut debris and rough cut edges as discussed above.

### SUMMARY

This section provides a general summary of the disclosure, and is not a comprehensive disclosure of its full scope or all of its features.

An ultrasonic system and method for cutting soft material has an ultrasonic transducer that vibrates axially at least one horn blade having a serrated edge so that when the horn blade is moved into the material being cut, it is vibrating in a direction in and out of the material being cut to make a plunge cut. The soft material being cut is placed in the ultrasonic system and the horn blade moved into and through the material being cut.

In an aspect, the serrated edge of the horn blade has a plurality of serrations with sharp points that vibrate axially when the horn blade is vibrating axially. In an aspect, the serrated edge of the ultrasonic horn knife is straight. In an aspect, the serrated edge is convex. In an aspect the serrated edge is concave.

In an aspect, the serrated edge of the horn blade is V-shaped with right and left sides of the serrated edge meeting at a center of the serrated edge at a sharp point. In an aspect, the serrated edge of the horn blade has a concave lead from both a right and left side of the edge of the horn blade that form the sharp point where they meet.

In an aspect, the horn blade is vibrated at a frequency in the range of 20 kHz to 60 kHz.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of a prior art ultrasonic cutting system;

FIG. 2 is a schematic view of an ultrasonic cutting system in accordance with an aspect of the present disclosure;

FIG. 3 is a perspective view of an ultrasonic horn blade of the ultrasonic cutting system of FIG. 2;

FIG. 4 is a perspective view of another embodiment of an ultrasonic horn blade in accordance with an aspect of the present disclosure;

FIG. 5 is a perspective view of another embodiment of an ultrasonic horn blade in accordance with an aspect of the present disclosure;

FIG. 6 is a perspective view of another embodiment of an ultrasonic horn blade in accordance with an aspect of the present disclosure; and

FIG. 7 is a schematic view of the ultrasonic cutting system of FIG. 2 having a plurality of horn blades.

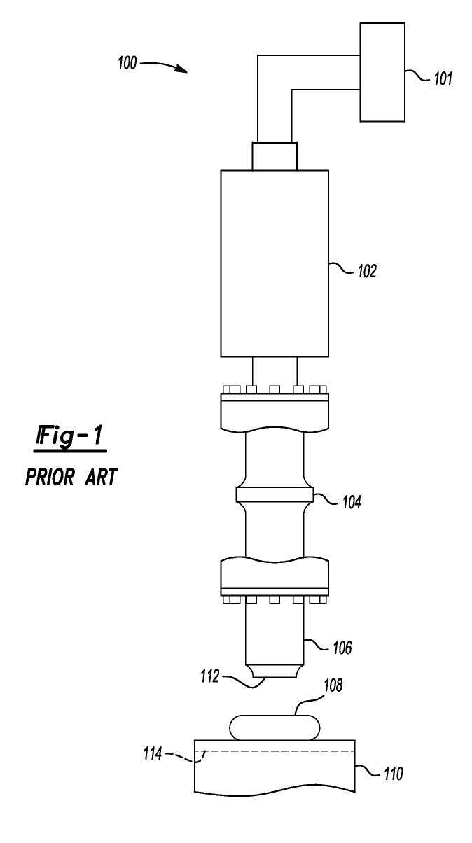

Corresponding reference numerals indicate corresponding parts throughout the several views of the drawings.

### DETAILED DESCRIPTION

Example embodiments will now be described more fully with reference to the accompanying drawings.

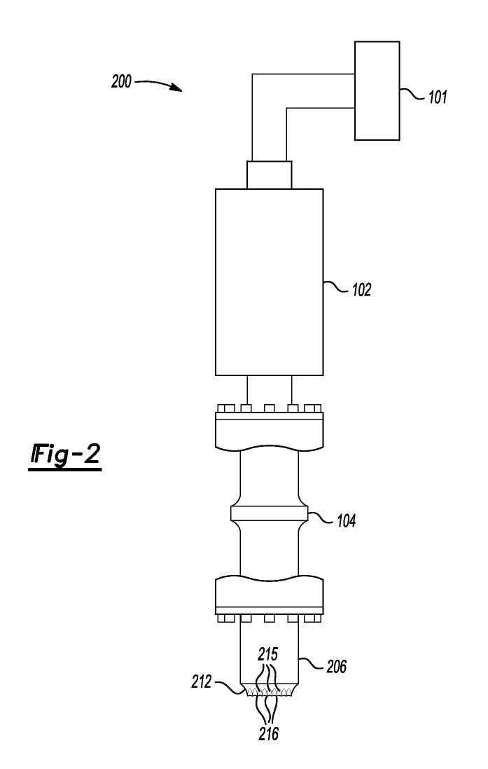

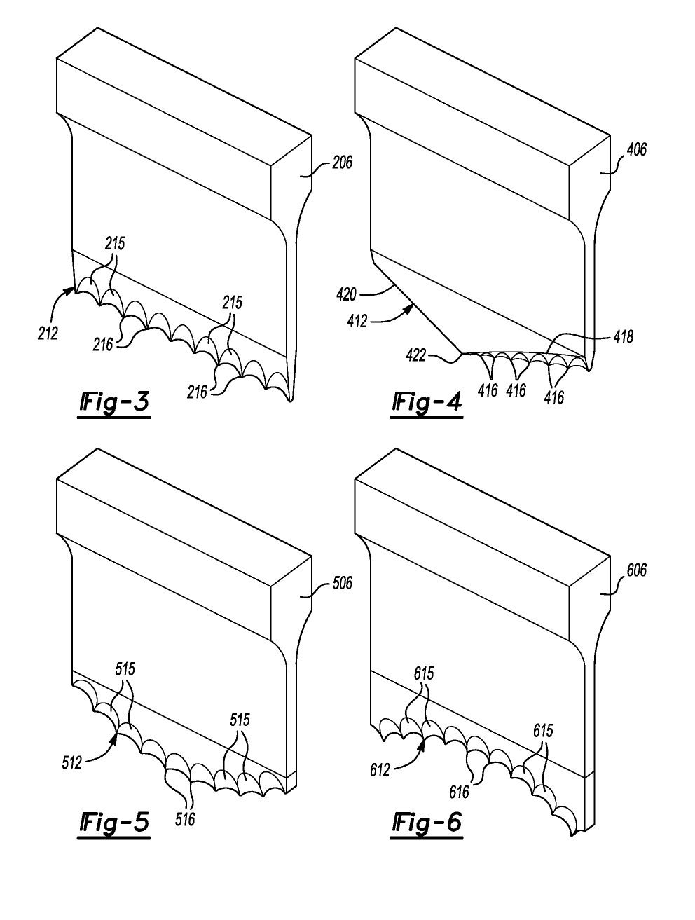

FIG. 2 shows an ultrasonic system 200 for cutting soft materials in accordance with an aspect of the present disclosure. Ultrasonic system 200 has the same components as ultrasonic system 100, which are identified with the same reference numerals, with the exception of horn blade 206 and that it is vibrated axially as opposed to laterally as discussed in more detail below. Edge 212 of horn blade 206 is not a smooth edge. Rather, in an aspect, it is a serrated edge having a plurality of serrations 215 with sharp points 216 as shown in more detail in FIG. 3.

In operation, ultrasonic system 200 is energized and ultrasonically vibrating horn blade 206 moved down into material 108 received on a cutting board 110 which cuts material 108 with an edge 212 of horn blade 106. Horn blade 206 is vibrated axially so that it makes a plunge cut when it moves down into material 108. That is, horn blade 206 vibrates in a direction that is in and out of material 108 to make the plunge cut. With respect to the orientation of ultrasonic system 200 in FIG. 2, axially is vertically. In this regard, when edge 212 is a serrated edge, the serrations vibrate axially when the horn blade is vibrating axially.

Illustratively, ultrasonic transducer 102 vibrates horn blade 206 at a frequency in the range of 20 kHz to 60 kHz.

In another embodiment shown in FIG. 4, horn blade 406 has a V-shaped serrated edge 412 with a series of sharp points 416 with right and left sides 418, 420 (as oriented in FIG. 4) of edge 412 meeting at a sharp point 420 at a center of edge 412. In the embodiment shown FIG. 4, right and left sides 418, 420 have concave leads that meet to form the point 422. In another embodiment shown in FIG. 5, horn blade 506 has a convex curved serrated edge 512 having a series of serrations 515 with a series of sharp points 516. In another embodiment shown in FIG. 6, horn blade 606 has a concave curved serrated edge 612 having a series of serrations 615 with a series of sharp points 616. It should be understood that the horn blade can have edges having other configurations with the edges having one or more sharp points.

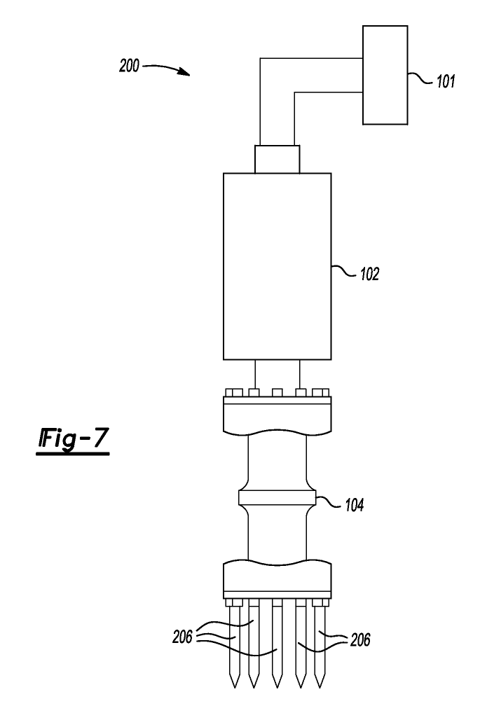

Ultrasonic system 200 may have a plurality of horn blades, such as horn blades 206, coupled to booster 104 as shown in FIG. 7. While shown as horn blades 206, it should be understood that the horn blades could also be any of horn blades 406, 506 and 606.

Ultrasonic system 200 may be used advantageously to cut hard crusted and spongy food products, which are both soft material. Hard crusted food products are food products that have a hard crust but a soft interior, such as certain breads.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. An ultrasonic system for cutting soft material, comprising an ultrasonic transducer that vibrates axially at least one horn blade having a serrated edge so that when the horn blade is moved into the material product being cut, it is vibrating in a direction in and out of the material to make a plunge cut.

2. The system of claim 1 wherein the serrated edge of the horn blade has a plurality of serrations with sharp points that vibrate axially when the horn blade is vibrating axially.

3. The system of claim 2 wherein the serrated edge of the horn blade is convex.

4. The system of claim 2 wherein the serrated edge of the horn blade is concave.

5. The system of claim 1 wherein the serrated edge of the horn blade is V-shaped with right and left sides of the serrated edge of the horn blade meeting at a center of the serrated edge at a sharp point.

6. The system of claim 1 wherein the right and left sides of serrated edge of the horn blade have concave leads that form the sharp point where they meet.

7. The system of claim 1 wherein the ultrasonic transducer vibrates the horn blade at a frequency in the range of 20 kHz to 60 kHz.

8. The system of claim 1 wherein a booster couples the horn blade to the ultrasonic transducer.

9. The system of claim 1 wherein the ultrasonic transducer vibrates a plurality of horn blades axially.

10. The system of claim 1 wherein the soft material is a hard crusted food product or a soft spongy food product.

11. A method of cutting soft material, comprising:
placing the soft material in an ultrasonic system that includes an ultrasonic transducer;
vibrating at least one horn blade having a serrated edge axially with the ultrasonic transducer so that when the horn blade is moved into the material being cut, it is vibrating in a direction in and out of the material to make a plunge cut; and
moving the horn blade axially into and through the material being cut.

12. The method of claim 11 wherein vibrating the at least one horn blade axially includes vibrating a plurality of horn blades axially.

13. The method of claim 11 wherein the soft material is a hard crusted or soft spongy food product and placing the soft material in the ultrasonic system includes placing the hard crusted food product or soft spongy food product in the ultrasonic system.

14. The method of claim 11 wherein vibrating the at least one horn blade axially includes vibrating it at a frequency in the range of 20 kHz to 60 kHz.

15. The method of claim 11 wherein vibrating the at least one horn blade axially includes vibrating it at a frequency in the range of 20 kHz to 60 kHz.
